(19) United States
(12) Patent Application Publication
(10) Pub. No.: US 2026/0328285 A1
(43) Pub. Date: Oct. 22, 2026

(54) VEHICLE TRANSMISSION CONTROL

(71) Applicant: JAGUAR LAND ROVER LIMITED, Warwickshire (GB)

(72) Inventors: Elliott CLARKE, Whitley, Coventry, Warwickshire (GB); Alex HALL, Whitley, Coventry, Warwickshire (GB); Benjamin DUDBRIDGE, Whitley, Coventry, Warwickshire (GB)

(21) Appl. No.: 19/491,141

(22) PCT Filed: Jun. 6, 2024
(86) PCT No.: PCT/EP2024/065578

§ 371 Date: Dec. 8, 2025

(30) Foreign Application Priority Data
Jun. 8, 2023 (GB) 2308558.2

(51) Int. Cl. F16H 61/02; F16H 61/06

(52) U.S. Cl. CPC F16H 61/0213; F16H 61/061; F16H 2061/0216; F16H 2061/0244; F16H 2306/18; F16H 2306/50

(57) ABSTRACT

A control system for controlling a transmission of a vehicle includes first and second clutches. Engagement of the clutches is controllable to select transmission output drive ratios. When a first output drive ratio is selected due to the first clutch being engaged and the second clutch being disengaged, a control system is configured to receive an indication of a vehicle parameter; determine, in dependence on the indication of the vehicle parameter, that a manual shift is likely to be initiated; responsive to determining that the manual shift is likely to be initiated, output a signal to cause the second clutch to partially engage; and responsive to receiving a manual shift input confirming initiation of the manual shift, output a signal to cause the first clutch to disengage and the second clutch to fully engage, to thereby change from the first output drive ratio to a second output drive ratio.

### TECHNICAL FIELD

The present disclosure relates to vehicle transmission control.

Aspects of the invention relate to a control system, a transmission system, a vehicle, a method, and computer readable instructions.

### BACKGROUND

It is known to provide a transmission having multiple clutches that can be controlled to change an output transmission ratio.

For example, in a manually controllable automatic transmission, clutches are used to selectively connect or disconnect transmission components to each other and/or a transmission housing, in order to change the output transmission ratio.

Alternatively, in a dual clutch transmission, gears corresponding to odd gear selections are mounted on one shaft and gears corresponding to even gear selections are mounted on another shaft (the shafts may be coaxial). Each shaft is connected to its own clutch, which can be controlled to select which shaft is connected between a motor and an output shaft that drives the wheels of the vehicle.

At least in certain circumstances, it may be desirable to decrease the time taken to change between output gear ratios.

It is an aim of the present invention to address one or more of the disadvantages associated with the prior art.

### SUMMARY OF THE INVENTION

Aspects and embodiments of the invention provide a control system, a transmission system, a vehicle, a method, and computer readable instructions as claimed in the appended claims.

According to an aspect of the present invention there is provided a control system for controlling a transmission of a vehicle, the transmission comprising at least first and second clutches, engagement of the first and second clutches being controllable to select output drive ratios of the transmission, the control system comprising one or more controllers, the control system configured to:
while a first output drive ratio is selected due to the first clutch being engaged and the second clutch being disengaged, receive an indication of a vehicle parameter;
determine, in dependence on the indication of the vehicle parameter, that a manual shift is likely to be initiated;
responsive to determining that the manual shift is likely to be initiated, output a signal to cause the second clutch to partially engage; and
responsive to receiving a manual shift input confirming initiation of the manual shift, output a signal to cause the first clutch to disengage and the second clutch to fully engage, thereby to change from the first output drive ratio to a second output drive ratio.

The one or more controllers collectively comprise at least one electronic processor having an electrical input for receiving an input signal; and at least one memory device electrically coupled to the at least one electronic processor and having instructions stored therein. The at least one electronic processor is configured to access the at least one memory device and execute the instructions thereon.

By initiating partial engagement of the second clutch prior to receiving the manual shift input, the time taken for a change of gear to begin following receipt of the manual shift input may be reduced.

Partially engaging the second clutch may comprise causing the second clutch to take up clutch engagement slack without transmitting torque.

Partially engaging the second clutch may comprise causing the second clutch piston to fill with fluid prior to engagement.

This may reduce overheating and/or undue wear that might be caused by keeping the second clutch partially engaged for too long.

The transmission may be an automatic transmission comprising at least one planetary gearset, in which the first clutch is controllable to selectively brake or clutch a first gear in the planetary gearset and the second clutch is controllable to selectively brake or clutch a second gear in the planetary gearset.

The transmission may be an automatic transmission comprising at least first and second planetary gearsets, in which the first clutch is controllable to selectively brake or clutch a first gear in the first planetary gearset and the second clutch is controllable to selectively brake or clutch a second gear in the second planetary gearset. The vehicle parameter may comprise a rotation rate of a motor configured for driving the transmission, and/or a rotation rate of a component of the transmission; and determining that a manual shift is likely to be initiated may comprise determining, based on the vehicle parameter, that the rotation rate of the motor, and/or the rotation rate of the component of the transmission reaches or passes a rotation rate threshold.

This may allow partial engagement of the second clutch to be initiated when it is likely that a fast gearchange is desirable, i.e., when the rotation rate is above a threshold (e.g., when the vehicle is accelerating) or below a threshold (e.g., when the vehicle is decelerating).

The rotation rate threshold may vary at least partly in dependence upon a currently selected gear or transmission ratio.

The vehicle parameter may comprise a throttle setting; and determining that a manual shift is likely to be initiated may comprise determining, based on the vehicle parameter, that the throttle setting reaches or passes a throttle threshold.

This may allow partial engagement of the second clutch to be initiated when it is likely that a fast gearchange is desirable. For example, a relatively high throttle setting during acceleration may imply that a fast upward gearchange is desirable, and a relatively low throttle setting during deceleration may imply that a fast downward gearchange is desirable.

The vehicle parameter may comprise an output torque of a motor configured for driving the transmission, and/or an output torque of a component of the transmission; and determining that a manual shift is likely to be initiated may comprise determining, based on the vehicle parameter, that the output torque of the motor, and/or the output torque of a component of the transmission reaches or passes a torque threshold.

This may allow partial engagement of the second clutch to be initiated when it is likely that a fast gearchange is desirable. For example, a relatively high output torque of the motor and/or of a component of the transmission during acceleration may imply that a fast upward gearchange is desirable, and a relatively low output torque of the motor and/or of a component of the transmission during deceleration may imply that a fast downward gearchange is desirable.

The vehicle parameter may comprise a vehicle mode parameter that is indicative of a current driving mode of the vehicle; and determining that a manual shift is likely to be initiated may comprise determining, based on the vehicle parameter, that the current vehicle mode is indicative of a driving mode in which a faster manual shift is to be performed.

This may allow partial engagement of the second clutch to be initiated when it is likely that a fast gearchange is desirable. For example, the vehicle being in a “sports” driving mode may imply that a fast upward/downward gearchange is desirable, whereas the vehicle being in a “normal” or “eco” driving mode may imply that a normal gearchange speed is desirable.

The vehicle parameter may comprise a currently selected gear; and determining that a manual shift is likely to be initiated may comprise determining, based on the vehicle parameter, that the currently selected gear is one of a predetermined subset of all available gears.

This may allow implementation only when particular gear(s) are selected, which may help reduce wear or maintenance requirements of the transmission or other vehicle components.

The control system may be configured to output a signal to cause the partially engaged second clutch to disengage if the manual shift input is not received within a predetermined time period.

Disengaging the partially engaged second clutch in this manner may reduce clutch heating and/or wear that may be caused by continuing to hold the second clutch in the partially engaged state for too long.

The control system may be configured to output a signal indicative of the determination that the manual shift is likely to be initiated, and/or indicative of the second clutch having been partially engaged.

This may allow a corresponding indication to be provided to the driver, such that the driver knows when there will be a faster gearchange as a result of the partial engagement of the second clutch prior to the driver initiating a gearchange.

The control system may be configured to output a signal indicative of the transmission operating in a mode in which partial engagement of the second clutch will be initiated when it is determined, in dependence on the indication of the vehicle parameter, that a manual shift is likely to be initiated.

This may allow a corresponding indication to be provided to the driver, such that the driver knows the mode in which the transmission is operating.

The first and second clutches may form part of a dual clutch arrangement, the first clutch being operable to connect a selected gear of a first set of gears to an output shaft of the transmission, and the second clutch being operable to connect a selected gear of a second set of gears to an output shaft of the transmission.

According to a further aspect of the present invention there is provided a transmission system comprising:
a transmission comprising:
   at least one gearset;
   an output shaft for outputting torque from the transmission; and
   a first clutch for controlling at least a first element of the at least one gearset and a second clutch for controlling at least a second element of the at least one gearset, engagement of the first and second clutches being controllable to select output drive ratios at the output shaft; and
the control system of the preceding aspect.

According to a further aspect of the present invention there is provided a vehicle comprising the transmission system of the preceding aspect.

According to a further aspect of the present invention there is provided a method of shifting gear in a transmission comprising at least first and second clutches, engagement of the first and second clutches being controllable to select output drive ratios of the transmission, the method comprising:
while a first output drive ratio is selected due to the first clutch being engaged and the second clutch being disengaged, receiving an indication of a vehicle parameter;
determining, in dependence on the indication of the vehicle parameter, that a manual shift is likely to be initiated;
responsive to the determination that the manual shift is likely to be initiated, partially engaging the second clutch; and
responsive to receiving a manual shift input confirming initiation of the manual shift, disengaging the first clutch and fully engaging the second clutch, thereby to change from the first output drive ratio to a second output drive ratio.

According to a further aspect of the present invention there is provided computer readable instructions that, when executed by a computer, are arranged to perform a method according to the preceding aspect.

According to a further aspect of the present invention there is provided a control system for controlling a transmission of a vehicle, the transmission comprising at least first and second clutches, engagement of the first and second clutches being controllable to select output drive ratios of the transmission, the control system comprising one or more controllers, the control system configured to:
output a signal to cause the second clutch to partially engage; and
responsive to receiving a manual shift input confirming initiation of the manual shift, output a signal to cause the first clutch to disengage and the second clutch to fully engage, thereby to change from the first output drive ratio to a second output drive ratio.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described, by way of example only, with reference to the accompanying drawings, in which:

FIG. 1 shows a vehicle in accordance with an embodiment of the invention;

FIG. 2 shows a schematic view of the vehicle of FIG. 1;

FIG. 3 shows a control system in accordance with an embodiment of the invention;

FIG. 4 shows a transmission in accordance with an embodiment of the invention;

FIG. 5 shows a flowchart showing a method in accordance with an embodiment of the invention;

FIG. 6 shows a schematic view of a vehicle in accordance with an embodiment of the invention; and

FIG. 7 shows a graphic comparison of a gear change with and without partial engagement of a clutch.

### DETAILED DESCRIPTION

Throughout this application, the word “clutch” (and related words such as “clutching”, etc.) is used as it would be understood by the skilled person in the context of transmissions. In this context, “clutch” includes any device, element, or mechanism that operates to selectively transfer torque between two elements, at least one of which can rotate. A clutch can include an arrangement that, when engaged, locks or “brakes” a rotatable element relative to, for example, a housing, such that the rotating element cannot rotate relative to the housing (such an arrangement is sometimes referred to as a “brake”). A clutch can also include an arrangement that, when engaged, locks one rotatable element relative to another rotatable element, such that they rotate together but not relative to each other.

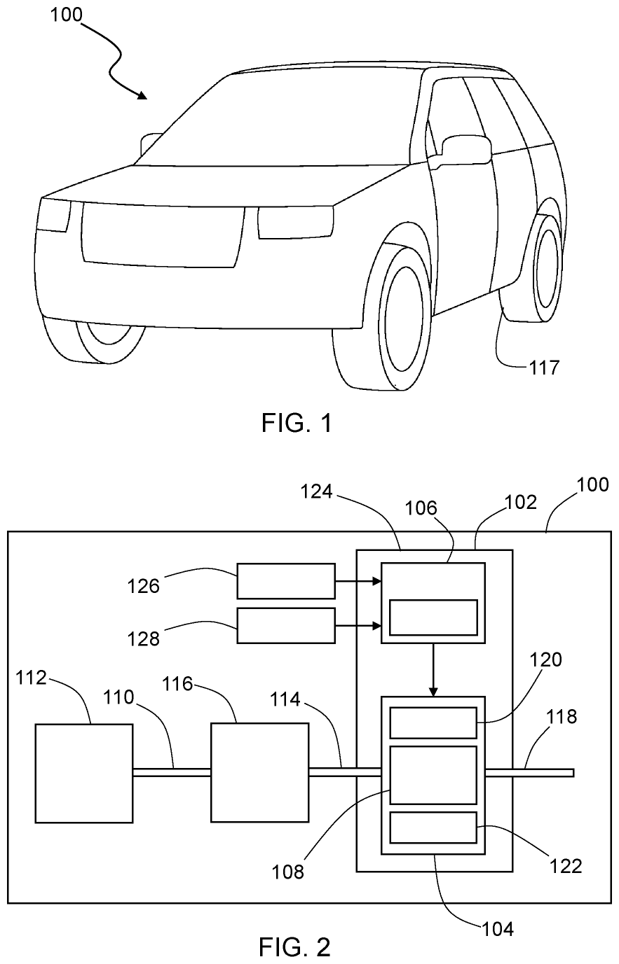

A control system and transmission system in accordance embodiments of the present invention are described herein with reference to the accompanying Figures. The control system and transmission system can be installed in a vehicle 100, as shown in FIG. 1. Although vehicle 100 is shown as a road-going car, other embodiments may be used in different vehicle types, including off-road vehicles, trucks, and motorcycles, for example.

With reference to FIG. 2, there is shown a schematic view of vehicle 100. Vehicle 100 comprises a transmission system 102 comprising a transmission 104 and a control system 106.

Transmission 104 comprises a gearset 108. In the implementation of FIG. 2, gearset 108 takes the form of a planetary gearset, as described in more detail below with reference to FIG. 4. However, it will be appreciated that one or more other types of gearset can be employed within transmission 104. For example, transmission 104 can comprise two or more planetary (and/or other) gearsets configured to offer multiple output gear ratios, in a manner known to the skilled person.

A motor 112 includes a motor output shaft 110, which in use transfers torque from motor 112 to a torque converter 116. Torque convertor 116 transfers torque to transmission 104 via a transmission input shaft 114. Transmission 104 transfers torque via a driveshaft 118 to drive road wheels (not shown in FIG. 2) such as rear wheels 117 in FIG. 1, via a differential gear (not shown), a transfer case (not shown) or other form of torque distribution arrangement.

Depending upon the implementation, motor 112 can comprise, for example, an internal combustion engine, an electric motor(s), a hybrid drive system comprising an internal combustion engine and an electric motor(s), or any other suitable generator of torque. Other drive transfer arrangements, such as a dry or wet clutch, can be employed to transfer torque from motor 112 to transmission 104, instead of, or in addition to, torque convertor 116.

Transmission 104 includes a first clutch 120 and a second clutch 122. First clutch 120 and second clutch 122 are friction clutches controlled by hydraulic clutch actuators under the control of control system 106, as described in more detail below with reference to FIG. 4. It will be appreciated that other types of actuators may be used in other implementations, such as electric motors, servos, and electromagnetic actuators.

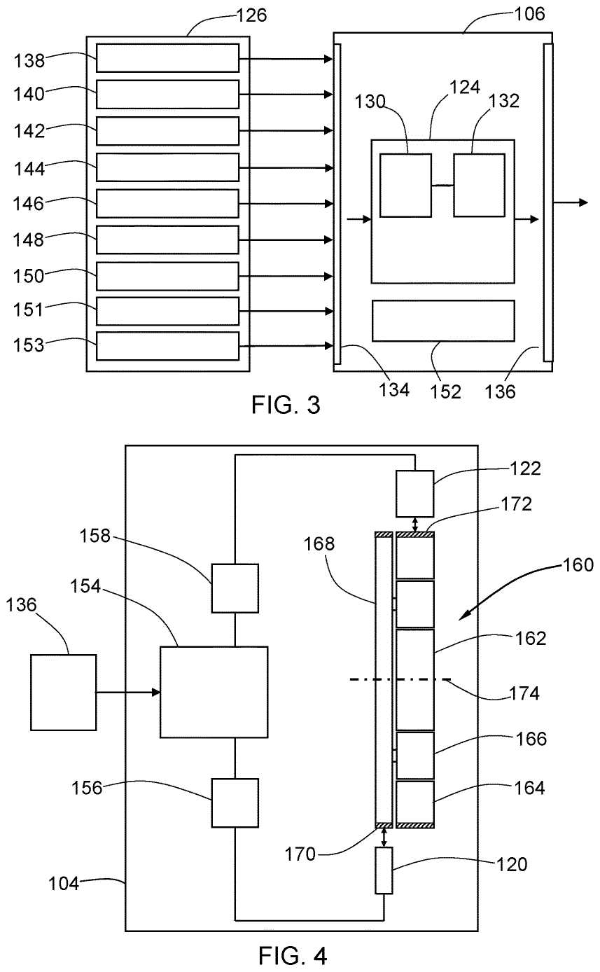

Control system 106 comprises a controller 124, details of which are described in more detail below in relation to FIG. 3. Control system 106 accepts as inputs vehicle parameters 126, examples of which are described in more detail below in relation to FIG. 3. Control system 106 also accepts, as an input, a shift input 128, indicative of user gear selection. The shift input 128 can be indicative of the user gear selection in any suitable manner. For example, shift input 128 can be in the form of an explicit gear selection (e.g., “gear 2”) or a relative selection (e.g., “increment [or decrement] current selected gear”). The shift input 128 can be the result of a driver using paddles or tip-shifter (not shown), for example, although other forms of gear shifter may be used. Turning to FIG. 3, control system 106 and vehicle parameters 126 are shown schematically in more detail than in FIG. 2. Controller 124 of control system 106 comprises processing means in the form of an electronic processing device 130 that operably executes computer-readable instructions. Controller 124 also includes memory means in the form of a memory device 132. Memory device 132 is operatively coupled to processing device 130. Memory device 132 is configured to store instructions, and processing device 130 is configured to access memory device 132 and execute the instructions stored thereon.

Although control system 106 is shown as including a single, centralised electronic processing device 130 and memory device 132 within transmission system 102, the required processing means and memory storage means can be located separately or together at one or more locations within vehicle 100. In addition, two or more electronic processing devices may share the required processing in a parallel or serial fashion, optionally distributed across one or more locations within vehicle 100. Similarly, two or more memory devices may share the required storage, optionally distributed across one or more locations within vehicle 100.

Control system 106 comprises an input means in the form of an input 134 and an output means in the form of an output 136. Input 134 can comprise, for example, one or more analogue to digital converters, input ports, bus interfaces, interrupts, optical interfaces, or any other form of input. Output 136 can comprise, for example, one or more digital to analogue converters, output ports, bus interfaces, relays, optical interfaces, or any other form of output.

Input 134 is arranged to receive vehicle parameters 126. Several such vehicle parameters 126 are shown in FIG. 3 and will be described in detail below. It will be appreciated, however, that other vehicle parameters can be used as inputs. In addition, a smaller number of vehicle parameters 126 than those shown can be employed. For example, any combination or sub-combination of vehicle parameters 126 can be used as input(s).

The illustrated vehicle parameters 126 include:
A rotation rate 138 of the motor 112. This can be in the form of a signal, such as a number, representing the revolutions per minute (or equivalent parameter over a different time period) at which the motor is rotating.
A rotation rate 140 of a component of transmission 104. This can be in the form of a signal, such as a number, representing the revolutions per minute (or equivalent parameter over a different time period) at which a component, such as a particular shaft, gear, or other rotating element, is rotating.
A throttle setting 142. This can be in the form of a signal, for example indicating a number or percentage, representing an amount by which the accelerator pedal (not shown) is depressed by the driver.
An output torque 144 of motor 112. This can be in the form of a signal, for example indicating a number or percentage, representing a torque being output by motor 112.
An output torque 146 of a component of transmission 104. This can be in the form of a signal, for example indicating a number or percentage, representing a torque being output by a rotating element (such as a particular shaft, gear, or other rotating element) within transmission 104.
A vehicle mode parameter 148 that is indicative of a current driving mode of vehicle 100. Vehicle 100 can be operable in more than one driving mode, such as off-road, sport, eco, and other modes that are known in the art. A driving mode can be selectable by a user by way of user interface (not shown), and/or automatically selected by a control system of vehicle 100 based on factors such as current driving inputs from the driver, geo-location, and external conditions such as weather or temperature. For example, a sport driving mode can automatically be selected by vehicle 100 based on the driver depressing the throttle pedal by more than 90% (or some other predetermined proportion), optionally in conjunction with other factors such as those given as examples above.
A currently selected gear 150. This can be the form of a signal, such as a number, representing a currently selected gear. For example, first gear can be represented by the number ‘1’, second gear by the number ‘2’, and so on, although any other form of indication can be used. Similar information may be available via shift input 128, avoiding the need for the currently selected gear to be provided from elsewhere.
Braking pressure 151. This can be in the form of a signal, such as a number, representing a pressure being applied to a brake pedal (not shown). Alternatively, a simple Boolean value can be provided, indicative of whether the brakes are engaged or not.
An acceleration value 153. This can be in the form of a signal, such as a number, representing an acceleration (positive and/or negative) experienced by the vehicle, e.g. as a result of torque provided by motor 112, and/or braking forces.

Any number, percentage, or other representation of vehicle parameters 126 can take the form of filtered or otherwise modified versions of raw data upon which such vehicle parameters are based. For example, parameter values can be the result of filtering raw data to remove noise and/or smooth sudden changes. Parameter values can also be quantised or otherwise simplified representations of raw data.

FIG. 3 also shows an optional timer block 152. Timer block 152 can be a separate circuit within control system 106, or can form a functional block within the software executed by controller 124. The operation of timer block 152 is described in more detail below.

Turning to FIG. 4, there is shown a schematic of transmission 104, showing some of the functional elements it contains. As well as first clutch 120 and second clutch 122, transmission 104 includes a hydraulic system 154. Hydraulic system 154 includes one or more hydraulic pumps (not shown), hydraulic reservoirs (not shown), hydraulic valves (not shown), and other hydraulic components required to operate hydraulic actuators and other components within transmission 104. Hydraulic system 154 is controlled via output 136 of control system 106.

Transmission 104 includes a first actuator 156 and a second actuator 158. First actuator 156 and second actuator 158 are hydraulic actuators that control engagement of first clutch 120 and second clutch 122, under the control of hydraulic system 154 as described in more detail below.

Transmission 104 includes a gearset in the form of a planetary gearset 160, which is shown as a vertical section through the gearset along its axis of rotation 174. Planetary gearset 160 comprises a centrally positioned sun gear 162, a peripheral ring gear 164, and several planetary gears 166 mounted on a carrier 168. Sun gear 162, ring gear 164, and carrier 168 are mounted for coaxial rotation around axis 174, while planetary gears 166 are disposed between the inner teeth of ring gear 164 and the outer teeth of sun gear 162. Carrier 168 has a radially outer clutch surface 170, and ring gear 164 has a radially outer clutch surface 172.

For clarity, the connections of transmission input shaft 114 (to sun gear 162) and driveshaft 118 (to ring gear 164 and carrier gear 168 via a suitable coupling) to planetary gearset 160 are not shown, but will be well understood by the skilled person.

First clutch 120 is controllable by first actuator 156 to move between a disengaged position, in which there is no friction between first clutch 120 and clutch surface 170 of carrier 168, and an engaged position, in which there is sufficient friction between first clutch 120 and clutch surface 170 of carrier 168 to prevent rotation of carrier 168.

Similarly, second clutch 122 is controllable by second actuator 158 to move between a disengaged position, in which there is no friction between second clutch 122 and clutch surface 172 of ring gear 164, and an engaged position, in which there is sufficient friction between second clutch 122 and clutch surface 172 of ring gear 164 to prevent rotation of ring gear 164.

Engagement of first clutch 120 and second clutch 122 can be controlled to select output drive ratios at driveshaft 118. For example, by engaging first clutch 120 and disengaging second clutch 122, a first gear ratio can be selected. To change to a different gear ratio, first clutch 120 is disengaged and second clutch 122 is engaged.

Although only a single clutch is shown for each element of planetary gearset 160, it will be appreciated that each clutch can use two or more clutch mechanisms and/or or friction surfaces to help distribute friction and loadings. Similarly, although the clutches are shown as engaging friction surfaces on an outer periphery of elements of planetary gearset 160, it will be appreciated that friction surfaces can be disposed on the radially inner and/or axial surfaces of elements of planetary gearset 160, with the clutches configured to move into engagement in a corresponding radial or axial direction.

Although clutches are shown as having linearly moveable friction surfaces, other clutching mechanisms can be employed. For example, one or more of the clutches can take the form of a clutch-band that is engaged by the corresponding actuator tightening the clutch band onto a corresponding friction surface of the planetary gearset 160 element.

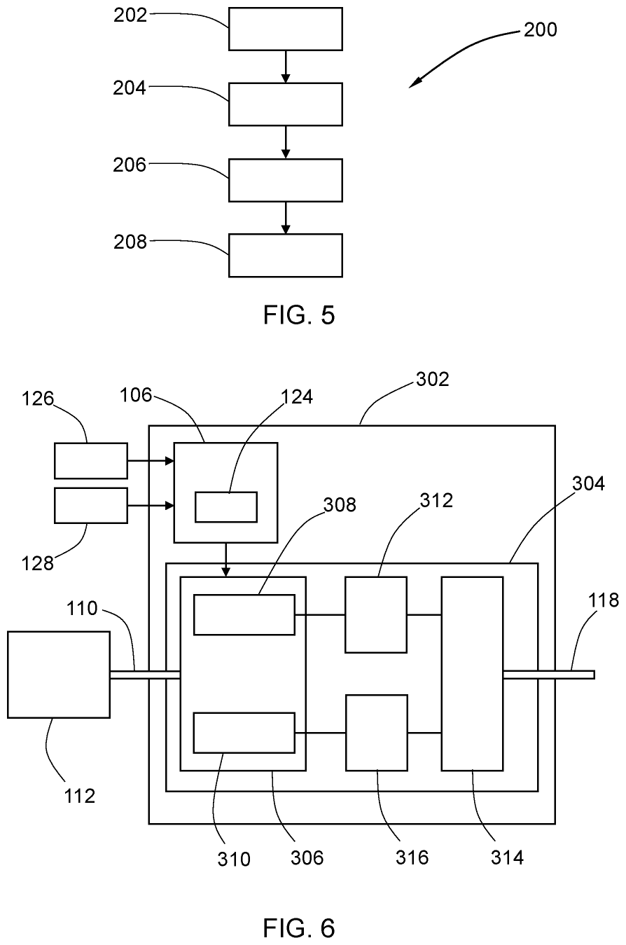

Control of transmission 104 based on vehicle parameters 126 will now be described with reference to the flowchart shown in FIG. 5, which shows a method 200 of causing transmission 104 to shift gear. Method 200 can be performed within control system 106, and in particular can be implemented by controller 124 executing software instructions as described above.

In accordance with method 200, while a first output drive ratio is selected due to first clutch 120 being engaged and second clutch 122 being disengaged, an indication of a vehicle parameter 126 is received 202. As explained above, one or more of such vehicle parameters 126 can be received.

Next, it is determined 204 that a manual shift is likely to be initiated, in dependence on the indication of the vehicle parameter(s) 126. The details of determination 204 will vary depending upon the particular vehicle parameters 126 upon which the determination is based.

Where vehicle parameter 126 comprises a rotation rate 138 of motor 112 or a rotation rate 140 of a component of transmission 104, determining that a manual shift is likely to be initiated can comprise determining, based on the vehicle parameter, that rotation rate 138 and/or rotation rate 140 exceeds a rotation rate threshold. In general, a higher rotation rate 138 of motor 112 or rotation rate 140 of a component of transmission 104 increases the likelihood of the driver initiating an up-shift, particularly if the rotation rate 138 or 140 is increasing and/or the vehicle is accelerating. Similarly, a lower rotation rate 138 of motor 112 or rotation rate 140 of a component of transmission 104 increases the likelihood of the driver initiating a down-shift, particularly if the rotation rate 138 or 140 is decreasing and/or the vehicle is decelerating. Beyond this threshold rotation rate, it can be concluded that a manual shift is likely to be initiated. The rotation rate threshold can be fixed, or can vary based on the values of other parameters, such as one or more of vehicle parameters 126, or other parameters that are measured or otherwise available to control system 106.

Where vehicle parameter 126 comprises a throttle setting 142, determining that a manual shift is likely to be initiated can comprise determining, based on the vehicle parameter, that throttle setting 142 exceeds a throttle threshold. In general, a higher throttle setting 142 increases the likelihood of the driver initiating an up-shift, particularly if the vehicle is accelerating. Similarly, a lower throttle setting 142 increases the likelihood of the driver initiating a down-shift, particularly if the vehicle is decelerating. Beyond a throttle threshold, it can be concluded that a manual shift is likely to be initiated. The throttle threshold can be fixed, or can vary based on the values of other parameters, such as one or more of vehicle parameters 126, or other parameters that are measured or otherwise available to control system 106.

Where vehicle parameter 126 comprises an output torque 144 of motor 112, and/or an output torque 146 of a component of transmission 104, determining that a manual shift is likely to be initiated can comprise determining that the output torque 144 of the motor 112, and/or the output torque of a component of transmission 104, exceeds a torque threshold. In general, a higher output torque 144 of motor 112, and/or output torque of a component of transmission 104, increases the likelihood of the driver initiating an up-shift, particularly if the vehicle is accelerating. Similarly, a lower output torque 144 of motor 112, and/or output torque 146 of a component of transmission 104 increases the likelihood of the driver initiating a down-shift, particularly if the vehicle is decelerating. It should be noted, however, that if engine braking is being employed, torque may still be high, but in an opposite direction relative to when the motor is generating torque. Beyond a torque threshold, it can be concluded that a manual shift is likely to be initiated. The torque threshold can be fixed, or can vary based on the values of other parameters, such as one or more of vehicle parameters 126, or other parameters that are measured or otherwise available to control system 106.

Where vehicle parameter 126 comprises a vehicle mode parameter 148 that is indicative of a current driving mode of vehicle 100, determining that a manual shift is likely to be initiated can comprise determining that the current vehicle mode is indicative of a driving mode in which a faster manual shift is to be performed. In general, vehicle 100 can be operable in more than one driving mode, at least one of which is associated with a faster gear shift. For example, in a vehicle having off-road, sport, and eco driving modes, a faster manual shift may be performed only in the sport mode. Alternatively, a current driving mode can be determined based on one or more vehicle parameters, with driver selection of the driving mode being only optional. For example, a throttle pedal position greater than, say, 80% for a period of time can be considered a driving mode in which a faster manual shift is to be performed.

Where vehicle parameter 126 comprises a currently selected gear 150, determining that a manual shift is likely to be initiated can comprise determining that the currently selected gear 150 is one of a predetermined subset of all available gears. For example, it can be determined that a manual shift is likely to be initiated only when the currently selected gear is the first, second, or third gear of a 6-speed gearbox. The particular subset of gears, and the total number of available gears, will vary depending upon the implementation.

Where vehicle parameter 126 comprises braking pressure 151, determining that a manual shift is likely to be initiated can comprise determining whether the braking pressure is above or below a threshold. For example, it can be determined that a manual up-shift is likely to be initiated only when the braking pressure is zero. Alternatively, or in addition, it can be determined that a manual up-shift is likely to be initiated only when the braking pressure exceeds a threshold (or has a “true” value if the braking pressure is Boolean).

Where vehicle parameter 126 comprises an acceleration value 153, determining that a manual shift is likely to be initiated can comprise determining that the acceleration is above a threshold (for an up-shift) or below a threshold (for a down-shift).

Although examples are given of how individual vehicle parameters 126 can be used as input(s) to determining that a manual shift is likely to be initiated, it will be appreciated that any combination or sub-combination of vehicle parameters 126 can be used as input(s). For example, determining that a manual up-shift is likely to be initiated can involve determining that the vehicle is in a particular driving mode (e.g., sport mode), that the currently selected gear is one of a particular subset of available gears (e.g., gears 1-3 of a 6-speed gearbox), that the current throttle setting exceeds a throttle threshold (e.g., >90% throttle pedal depression), and that the vehicle is accelerating (e.g., vehicle speed increasing at a rate greater than X km/h per second, or Y mph per second). Alternatively, determining that a manual up-shift is likely to be initiated can involve determining that the current throttle setting exceeds a throttle threshold (e.g., >80% throttle pedal depression), and that the rotation rate of motor 112 or a component of transmission 104 (e.g., transmission input shaft 114) exceeds a rotation rate threshold (e.g., 90% of redline rotation rate, or a specific rotation rate, e.g., 6,000 r.p.m.).

Alternatively, or in addition, determining that a manual down-shift is likely to be initiated can involve determining that the vehicle is in a particular driving mode (e.g. sports mode), that the currently selected gear is one of a particular subset of available gears (e.g., gears 2-5 of a 6-speed gearbox), that the current throttle setting is below a throttle threshold (e.g., <10% throttle pedal depression), and that the rotation rate of motor 112 or a component of transmission 104 (e.g., transmission input shaft 114) is below a rotation rate threshold (e.g., 3,000 r.p.m.). Alternatively, determining that a manual downshift is likely to be initiated can involve determining that the current throttle setting is below a throttle threshold (e.g., <5% throttle pedal depression), and that the rotation rate of motor 112 or a component of transmission 104 (e.g., transmission input shaft 114) is below a rotation rate threshold (e.g., 4,000 r.p.m.). Optionally, the co-existence of braking pressure (optionally exceeding a braking pressure threshold) can be used as part of determining that a manual down-shift is likely to be initiated.

Any other combination or sub-combination of parameters can be employed to suit particular implementation requirements. Different thresholds and values can be applied to different combinations of parameters. For example, a different threshold can be applied to the throttle setting, dependent on the currently selected gear. For example, a first threshold can be employed for gears 1-3 (of 6, say), and a second threshold employed for gears 4-6. Alternatively, a different threshold can be employed for each gear.

Optionally, different parameters and parameter combinations can be used for up-shifting and down-shifting.

Returning to FIG. 5, responsive to the determining 204 that the manual shift is likely to be initiated, second clutch 122 is partially engaged 206.

Partial engagement of second clutch 122 can take any suitable form. For example, partial engagement can involve applying some proportion (i.e., less than 100%) of the hydraulic pressure known to be required to cause full engagement of second clutch 122 (hereinafter the “engagement pressure”) with the clutch surface 172 of ring gear 164.

For example, from manufacturer specifications or testing, it may be determined that second actuator 158 does not start movement of second clutch 122 until the hydraulic pressure applied to second clutch 122 by second actuator 158 exceeds 50% (for example) of the full engagement pressure, and that second clutch 122 does not start transferring substantial torque to ring gear 164 until the hydraulic pressure exceeds 80% of the full engagement pressure. In this example, partial engagement can involve applying less than 50% of the engagement pressure or less than 80% of the engagement pressure. Applying less than 50% of the engagement pressure reduces the possibility of undesirable friction between second clutch 122 and the clutch surface 172 of ring gear 164. Applying more than 50%, but less than 80%, of the engagement pressure increases the possibility of such undesirable friction, but can improve the perceived speed of the gearchange, as described in more detail below. Optionally, any other value, such as a value between 50% and 80% (in this example) can be selected to suit implementation requirements.

Alternatively, or in addition, partial engagement of second clutch 122 can involve the use of feedback. For example, one or more sensors (not shown) can be used to estimate a distance between second clutch 122 and clutch surface 172. The partial engagement can involve increasing the hydraulic pressure applied to second clutch 122 by second actuator 158 by an amount that does not result in significant torque being transferred between second clutch 122 and clutch surface 172. Alternatively, or in addition, one or more sensors (not shown) can be used to estimate torque transmitted between second clutch 122 and clutch surface 172. This estimate can be used to calibrate the amount of hydraulic pressure that can be applied to second clutch 122 by second actuator 158 without resulting in significant torque being transferred between second clutch 122 and clutch surface 172. Such calibration can be undertaken continuously, periodically, occasionally, and/or responsive to parameters such as transmission temperature or vehicle mileage.

Partially engaging second clutch 122 can comprise causing the second clutch 122 to take up clutch engagement slack without transmitting significant torque. Such slack can include, for example, hysteresis and/or slop in hydraulic and/or mechanical connections and linkages controlling the clutches, and within the clutches themselves. Such slack can also be considered to include the hydraulic pressure (or other actuation force) needed to preload the hydraulic system prior to clutch movement.

Partially engaging second clutch 122 can additionally, or alternatively, comprise causing the piston actuating the second clutch 122 to fill with hydraulic fluid. It is common for the piston to drain when disengaged and the piston must be filled before the clutch can start to engage.

Once second clutch 122 has been partially engaged 206, control system 106 is effectively waiting for a manual shift input from the driver, confirming that the anticipated manual shift has been initiated. In the context of FIG. 4, first clutch 120 is fully engaged with clutch surface 170 of carrier 168, while second clutch 122 is partially engaged such that no torque is transferred to clutch surface 172 of ring gear 164.

In general, the anticipated manual shift will be sequential (i.e., involve shifting up or down by a single gear) and in a particular direction (i.e., the anticipated manual shift can be an up-shift or a down-shift, but not both). In certain scenarios and implementations, however, it is possible that a nonsequential gear shift can be anticipated (optionally in addition to an anticipated sequential shift), and/or that both an up-shift and a down-shift can be anticipated. In those cases, and depending upon the configuration of the gearbox and clutches, it may be necessary to partially engage more than one clutch to enable shifting to more than one possible gear depending on what manual shift input is received.

The manual shift input can be the result of the driver up-shifting or down-shifting using paddles or a tip-shifter, for example. It will be appreciated that other types of gear-shifting mechanism can be employed in different implementations.

Returning to FIG. 5, responsive to receiving a manual shift input confirming that the manual shift is initiated, first clutch 120 is disengaged and second clutch 122 is fully engaged 208, thereby to change from the first output drive ratio to a second output drive ratio. In the context of FIG. 4, this involves first clutch 120 disengaging from clutch surface 170 of carrier 168, allowing carrier 168 to rotate. Second clutch 122 fully engages with clutch surface 172 of ring gear 164, stopping ring gear 164 from rotating. There will be a transition period where some slippage of second clutch takes places, to make the process feel smoother from the driver's perspective and to reduce peak loads during the gearchange. The end result is a change in the output drive ratio of driveshaft 118 from a first output drive ratio to a second output drive ratio.

Depending upon the implementation, second clutch 122 can remain partially engaged 206 (with control system 106 waiting for a manual shift input) indefinitely. However, a limit can optionally be placed on how long second clutch 122 remains partially engaged. Implementing such a limit can reduce the risk of overheating and/or undue wear on clutch components, especially if partial engagement of the clutch raises the possibility of minor friction between the clutch and corresponding clutch surface on the element(s) that it clutches or brakes.

There are a number of ways in which such a limit can be placed on partial engagement of second clutch 122. For example, with reference to FIG. 3, timer block 152 can implement a timer. The timer can be initiated at any suitable time, such as at the commencement of step 206 in method 200 (i.e., as soon as the partial engagement process is initiated) or when the partial engagement process is complete. The timer can be different depending upon, for example, any of vehicle parameters 126, or other parameters not specifically mentioned. For example, particular clutches can be more prone to wear or other potential problems if they are kept at partial engagement for too long. Such clutches can have a shorter timer period associated with them. Clutches not at risk may not use the timer.

Once the timer block 152 determines that the timer has run out without the anticipated manual shift input being received, second clutch 122 is disengaged. If the driver keeps the throttle open, the motor may hit the rev limiter. If the driver chooses to initiate the anticipated gearchange after the second clutch is disengaged, then a normal gearchange (i.e., without anticipatory partial engagement of second clutch 122) can be performed.

Second clutch 122 can be partially engaged again if the required conditions are subsequently met. Optionally, there can be a delay before allowing second clutch 122 to be partially engaged again if the anticipated manual shift input was not previously received, especially if there have been repeated failures to move from partial engagement to full engagement.

It will be appreciated that method 200 can optionally be performed with the roles of first clutch 120 and second clutch 122 reversed. That is, first clutch 120 is partially engaged and second clutch 122 is fully engaged while anticipating a manual shift input. It will be appreciated that the manual shift input in this case will be in the opposite direction to that described above (in terms of being a down-shift rather than an up-shift, or vice versa). An indication can optionally be provided to let the driver know that method 200 is in operation. The indication can take the form of, for example, one or more lights, visual messages, audible cues (such as a tone or spoken message), haptics (a vibration pattern through the steering wheel or seat, for example), or the like. Based on this indication, the driver is aware that faster gearchanges are to be expected if and when the relevant requirements (i.e., vehicle parameter values) are met.

Alternatively, or in addition, an indication can optionally be provided to let the driver know when a clutch has been partially engaged (or that such partial engagement has been initiated). As with the previously-described indication, this indication can take the form of, for example, one or more lights, visual messages, audible cues (such as a tone or spoken message), haptics (a vibration pattern to the steering wheel or seat, for example), or the like. Based on this indication, the driver is aware that incrementing (if the vehicle is accelerating) or decrementing (if the vehicle is decelerating) gears following this indication will result in a faster upshift or downshift, respectively.

As one non-limiting example, an indication may be provided in the form of a “shift light”, which can be a separate light in the driver's field of view or can be an icon or other visual indicator on a display within the vehicle. The shift light can be controlled to change to a first colour (e.g., green) to indicate to the driver that the is transmission operating in a mode in which partial engagement of the second clutch will be initiated when it is determined, in dependence on the indication of the vehicle parameter, that a manual shift is likely to be initiated. Once the parameters are met, the light can change to a different colour (e.g., red) to indicate that the faster gearchange will happen if the driver initiates a manual shift. A single colour shift light can alternatively be used to communicate only one of the indications described above.

FIG. 4 shows a highly simplified gearset for the purpose of illustrating operation of a particular implementation. More complex gearboxes and gearsets can be employed in other implementations. For example, multiple planetary (and/or other) gearsets can be employed to provide a greater number of output drive ratios. For example, the transmission can be an automatic transmission comprising at least two planetary gearsets, each gearset having one or more clutches. In terms of the detailed description above, the first clutch can be in one planetary gearset and the second clutch can be in the same or another of the planetary gearsets. More than two clutches can be required to allow gear selection in different implementations. For example, in a modern automatic transmission comprising several planetary gearsets, there will often be multiple clutches per gearset.

Turning to FIG. 6, there is shown a transmission system 302. Transmission system 302 shares a number of features with transmission system 102, and similar features are indicated with like reference signs. It will be understood that implementation details can vary for features with the same reference signs, to account for practical differences between transmissions 102 and 302.

Transmission system 302 is a dual clutch transmission. It is not necessary to describe the detailed operation of such transmissions in order to understand the implementation of FIG. 6, and so only details relevant to the embodiment will be described in detail.

Transmission system 302 includes a transmission 304, which in turn comprises gears 306. Gears 306 comprise a first gearset 308 and a second gearset 310. Although shown as separated within transmission 304 for clarity, first gearset 308 is typically mounted to a gear-shaft (not shown) that is coaxial with a hollow gear shaft (not shown) to which second gearset 310 is mounted.

A first clutch 312, when engaged, causes drive from motor output shaft 110 to be output to output gears 314 via a selected gear of first gearset 308, while a second clutch 316, when engaged, causes drive from input shaft 110 to be output to output gears 314 via a selected gear of second gearset 310. First clutch 312 and second clutch 316 are controlled by control system 106 such that only one is engaged at a time.

In contrast with planetary transmission 104, gear selection in transmission 304 is performed by a gear selector (not shown) for each of first gearset 308 and second gearset 310, in a manner understood by the skilled person. For example, first gearset 308 can include oddly-numbered forward gears and second gearset 310 can include evenly-numbered forward gears.

In use, a gear is selected by the driver. Control system 106 causes a selector in the corresponding first gearset 308 or second gearset 310 to be selected. For the purpose of this example, the driver selects first gear, which is in first gearset 308.

As the driver depresses the throttle pedal, control system 106 causes first clutch 312 to gradually engage, and vehicle 100 begins to move, with torque passing from input shaft 110, through selected first gear in first gearset 308, output gears 314, and out through driveshaft 118. In anticipation of the driver changing from first to second gear, control system 106 causes pre-selection of second gear in second gearset 310 while second clutch 316 is disengaged.

The driver selects second gear by way of, for example, a paddle or a tip-shifter. Control system 106 disengages first clutch 312, and engages second clutch 316, such that torque passes from input shaft 110, through selected second gear in second gearset 310, output gears 314, and out through driveshaft 118.

Depending upon throttle conditions and other factors, control system 106 can then pre-select third gear or first gear within first gearset 308 as required.

Perceived shift speed can be improved by implementing the method of FIG. 5 with the implementation of FIG. 6. While a first output drive ratio (first gear, for example) is selected due to first clutch 312 being engaged and second clutch 316 being disengaged, an indication of a vehicle parameter is received. Examples of such vehicle parameters include those described above in relation to FIG. 3. It can then be determined that a manual shift is likely to be initiated, in dependence on the indication of the vehicle parameter.

Responsive to the determination that the manual shift is likely to be initiated, second clutch 316 is partially engaged, for example as described above in relation to the FIG. 4 implementation.

Responsive to receiving a manual shift input confirming that the manual shift has been initiated by the driver, first clutch 312 is disengaged and second clutch 316 is fully engaged, thereby to change from the first output drive ratio to a second output drive ratio (e.g., second gear).

All of the options and alternatives described in relation to the FIG. 4 implementation apply to the fullest possible extent to the FIG. 6 implementation.

In relation to all implementations, partially engaging a clutch in anticipation of receiving a manual gearchange indication can reduce the total time from the driver choosing to change gears and the gear actually changing, at least where the predicted gear change takes place.

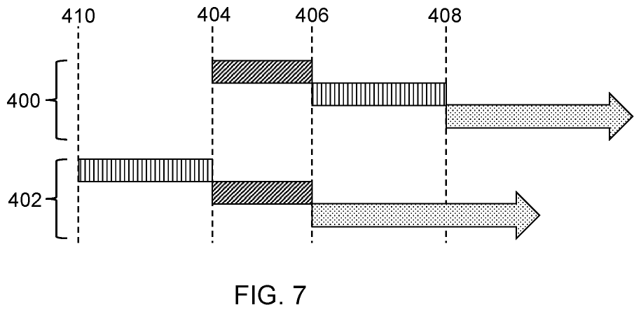

FIG. 7 shows a graphic comparison of a gear change with and without partial engagement of a clutch as described. Upper example 400 shows a shift sequence in which partial clutch engagement is not used, and lower example 402 shows a shift sequence in which partial clutch engagement is used.

In upper example 400, at time 404, an indication is received that a manual shift has been initiated (it is assumed for the purposes of this comparison that all other requirements for allowing the shift to be performed are met). This can be, for example, a signal received via a paddle or tip-shift indicating that a sequential gearchange is required. There is a delay from time 404 to time 406 which includes network transmission and processing delays following driver interaction with the gearshifter. Depending upon the vehicle and control system, this delay can be of the order of, for example, 120 ms.

At time 406, engagement of the clutch is initiated in response to the indication that a manual shift has been initiated, and actuation of the clutch begins. At time 408, engagement of the clutch reaches the point where it begins to transmit torque (i.e., the “bite” point). Depending upon the transmission system, the period between times 406 and 408 can be of the order of 200 ms for example, but the period will vary depending on the implementation. The driver will perceive a change in motor speed and torque delivery after this time 408.

The total perceived delay between initiating a gearchange and initially perceiving a change in motor speed and torque delivery is therefore the sum of the network and processing delay, and the period before torque transfer begins after time 408. Using the example periods given above, this gives a total of around 320 ms.

In lower example 402, the first step is partial engagement of the clutch starting at time 410, responsive to it having been determined that a manual shift is likely to be initiated (i.e., based on the vehicle parameters as described above). This takes place prior to the driver indicating that a manual shift is required.

At time 404, an indication is received that a manual shift has been initiated (the time at which this indication is received has been aligned in upper example 400 and lower example 402 to allow a visual comparison of the time from the initiation to the perceived change in motor speed and torque delivery in both examples). This can again be, for example, a signal received via a paddle or tip-shift indicating that a sequential gearchange is required. There is a similar delay between times 404 and 406 due to network transmission and processing delays. Depending upon the vehicle and control system, this delay can be of the order of, for example, 120 ms.

Because the clutch was partially engaged before receipt of the indication that a manual shift was initiated, further engagement of the clutch into and beyond the initial “bite” point allows it to commence transferring torque with less delay compared to that in upper example 400, such that the driver will perceive a change in motor speed and torque delivery almost immediately after time 406.

In lower example 402, the total perceived delay between initiating a gearchange and initially perceiving a change in motor speed and torque delivery is the network transmission and processing delay, plus any small delay involved with further engagement of the clutch into and beyond the initial “bite” point. Using the example periods given above, this gives a total of a little more than around 120 ms.

It will be appreciated that the time periods given above are examples only, and that different periods can apply to different implementations. Also, there can still be some time required to take the clutch from partial to full engagement, depending upon how close to the “bite” point the partial engagement is taken. Nevertheless, partially engaging the clutch can significantly reduce the perceived time from initiating a gearchange to there being a perceived change in torque delivery. It will also be appreciated that the perceived time can still be reduced even if the gearchange is initiated before the partial engagement process has completed.

Although embodiments have been described with reference to hydraulic actuation and control of clutches/brakes, it will be appreciated that other forms of actuation and control can be used. For example, mechanical, electro-mechanical, magnetic, electric, pressurised gas, or any other actuator type(s) can be used. Partial engagement of a clutch/brake can, for example, be controlled based on force applied to, and/or distance moved by, the clutch by such actuators.

In yet other implementations, one or more of the clutches can be biased into the engaged position by a biasing mechanism. In that case, hydraulic pressure (or other actuator force) is applied to disengage the clutch as required. In such configurations, partial engagement of a clutch involves reducing the hydraulic pressure (or other actuator force), but not so much that the clutch engages.

For purposes of this disclosure, it is to be understood that reference to ‘the control system configured to’ is to be understood to mean ‘the one or more controllers of the control system are collectively configured to’. The controller(s) described herein can each comprise a control unit or computational device having one or more electronic processors, the one or more processors collectively configured to perform the control system functionality set out in the control system claims.

It will be appreciated that various changes and modifications can be made to the present invention without departing from the scope of the present application.

1. A control system for controlling a transmission of a vehicle, the transmission comprising at least first and second clutches, engagement of the first and second clutches being controllable to select output drive ratios of the transmission, the control system comprising one or more controllers, the control system configured to:
while a first output drive ratio is selected due to the first clutch being engaged and the second clutch being disengaged, receive an indication of a vehicle parameter;
determine, in dependence on the indication of the vehicle parameter, that a manual shift is likely to be initiated;
responsive to determining that the manual shift is likely to be initiated, output a signal to cause the second clutch to partially engage; and
responsive to receiving a manual shift input confirming initiation of the manual shift, output a signal to cause the first clutch to disengage and the second clutch to fully engage, thereby to change from the first output drive ratio to a second output drive ratio.

2. The control system of claim 1, wherein partially engaging the second clutch comprises causing the second clutch piston to fill with fluid and/or the second clutch to take up clutch engagement slack without transmitting torque.

3. The control system of claim 1, wherein the transmission is an automatic transmission comprising at least one planetary gearset, in which the first clutch is controllable to selectively brake or clutch a first gear in the planetary gearset and the second clutch is controllable to selectively brake or clutch a second gear in the planetary gearset.

4. The control system of any one of claim 1, wherein the transmission is an automatic transmission comprising at least first and second planetary gearsets, in which the first clutch is controllable to selectively brake or clutch a first gear in the first planetary gearset and the second clutch is controllable to selectively brake or clutch a second gear in the second planetary gearset.

5. The control system of claim 1, wherein:
the vehicle parameter comprises a rotation rate of a motor configured for driving the transmission, and/or a rotation rate of a component of the transmission; and
determining that a manual shift is likely to be initiated comprises determining, based on the vehicle parameter, that the rotation rate of the motor, and/or the rotation rate of the component of the transmission reaches or passes a rotation rate threshold.

6. The control system of claim 5, wherein the rotation rate threshold varies at least partly in dependence upon a currently selected gear or transmission ratio.

7. The control system of claim 1, wherein:
the vehicle parameter comprises a throttle setting; and
determining that a manual shift is likely to be initiated comprises determining, based on the vehicle parameter, that the throttle setting reaches or passes a throttle threshold.

8. The control system of claim 1, wherein:
the vehicle parameter comprises an output torque of a motor configured for driving the transmission, and/or an output torque of a component of the transmission; and
determining that a manual shift is likely to be initiated comprises determining, based on the vehicle parameter, that the output torque of the motor, and/or the output torque of a component of the transmission reaches or passes a torque threshold.

9. The control system of claim 1, wherein:
the vehicle parameter comprises a vehicle mode parameter that is indicative of a current driving mode of the vehicle; and
determining that a manual shift is likely to be initiated comprises determining, based on the vehicle parameter, that the current vehicle mode is indicative of a driving mode in which a faster manual shift is to be performed.

10. The control system of claim 1, wherein:
the vehicle parameter comprises a currently selected gear; and
determining that a manual shift is likely to be initiated comprises determining, based on the vehicle parameter, that the currently selected gear is one of a predetermined subset of all available gears.

11. The control system of claim 1, configured to output a signal to cause the partially engaged second clutch to disengage if the manual shift input is not received within a predetermined time period.

12. A transmission system comprising:
a transmission comprising:
at least one gearset;
an output shaft for outputting torque from the transmission; and
a first clutch for controlling at least a first element of the at least one gearset and a second clutch for controlling at least a second element of the at least one gearset, engagement of the first and second clutches being controllable to select output drive ratios at the output shaft; and
the control system of any one of the preceding claims.

13. A vehicle comprising the transmission system of claim 12.

14. A method of shifting gear in a transmission comprising at least first and second clutches, engagement of the first and second clutches being controllable to select output drive ratios of the transmission, the method comprising:
while a first output drive ratio is selected due to the first clutch being engaged and the second clutch being disengaged, receiving an indication of a vehicle parameter;
determining, in dependence on the indication of the vehicle parameter, that a manual shift is likely to be initiated;
responsive to the determination that the manual shift is likely to be initiated, partially engaging the second clutch; and
responsive to receiving a manual shift input confirming initiation of the manual shift, disengaging the first clutch and fully engaging the second clutch, thereby to change from the first output drive ratio to a second output drive ratio.

15. Computer readable instructions that, when executed by a computer, are arranged to perform a method according to claim 14.
